(19) United States
(12) Patent Application Publication
(10) Pub. No.: US 2024/0273019 A1
(43) Pub. Date: Aug. 15, 2024

(54) CACHE MANAGEMENT FOR WEB APPLICATION COMPONENTS

(71) Applicant: Dell Products L.P., Round Rock, TX (US)

(72) Inventors: Suraj Mohata, Bangalore (IN); Sisir Samanta, Bangalore (IN); Shibi Panikkar, Bangalore (IN)

(21) Appl. No.: 18/107,610

(22) Filed: Feb. 9, 2023

(51) Int. Cl. G06F 12/0802

(52) U.S. Cl. CPC G06F 12/0802; G06F 2212/60

(57) ABSTRACT

Methods, apparatus, and processor-readable storage media for cache management for web application components are provided herein. An example computer-implemented method includes maintaining information corresponding to a set of resources for a first version of a first component associated with a web application, wherein at least some of the resources in the set of resources are stored in a first portion of a browser cache, of a client device, corresponding to the first component; detecting one or more changes to the set of resources in response to a second version of the first component being deployed; and sending a notification of the changes to a client device, where the client device updates, based at least in part on the one or more changes, the first portion of the browser cache and a second portion of the browser cache corresponding to a second component that is dependent on the first component.

### FIELD

The field relates generally to information processing systems, and more particularly to web applications associated with such systems.

### BACKGROUND

A web application generally refers to software residing on one or more servers that is accessed by one or more client devices over a network. For example, web applications are often delivered over the internet to a web browser of a client device, and can provide users with functionality for performing one or more tasks without having to locally install the application.

### SUMMARY

Illustrative embodiments of the disclosure provide techniques related to cache management for web application components. An exemplary computer-implemented method includes maintaining information corresponding to a set of resources in a data structure for a first version of a first component of a plurality of components associated with a web application, wherein the plurality of components is used by at least one client device to interact with the web application, and wherein at least some of the resources in the set of resources are stored in a first portion of a browser cache corresponding to the first component; detecting one or more changes to the set of resources in response to a second version of the first component of the plurality of components being deployed; and sending a notification of the one or more changes to the at least one client device, wherein the at least one client device updates, based at least in part on the one or more changes, the first portion of the browser cache and at least a second portion of the browser cache corresponding to at least a second component of the plurality of components that is dependent on the first component.

In some embodiments, the components associated with the web application may comprise one or more micro-frontend (MFE) components.

Illustrative embodiments can provide significant advantages relative to conventional cache management techniques for MFE frameworks and other contexts involving web applications. For example, technical problems associated with crashes and/or inconsistencies of UI elements are mitigated in one or more embodiments by automatically identifying changes in resources associated with different versions of an MFE and sending a notification to client devices of such changes. A given client device can then update resources in a cache corresponding to the MFE based on the notification, and possibly at least one other cache corresponding to at least one dependent MFE.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for cache management for web application components in an illustrative embodiment.

FIGS. 2A and 2B show a caching and loading process for different versions of an MFE in an illustrative embodiment.

FIG. 3 shows an implementation of an MFE framework in an illustrative embodiment.

FIG. 4 shows a flow diagram of a server-side process for cache resource management in an illustrative embodiment.

FIG. 5 shows a flow diagram of a client-side process for cache resource management in an illustrative embodiment.

FIG. 6 shows an example of a metadata structure for an MFE in an illustrative embodiment.

FIG. 7 shows a flow diagram of a process for cache management for web application components in an illustrative embodiment.

FIGS. 8 and 9 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

Software architecture may be designed in various ways. In some architectures, software may provide a number of functions in the form of a single, monolithic application. A “monolithic application” refers to a single-tiered, tightly-coupled software application in which various elements of the software architecture (e.g., a user interface (UI), database access, processing logic, etc.) are combined into a single program, usually on a single platform.

Monolithic applications may suffer from disadvantages relating to innovation, manageability, resiliency, and scalability, particularly in computing environments such as cloud computing environments, datacenters, and converged infrastructure. As an alternative to such monolithic applications, some software architectures provide different functions in the form of components (e.g., microservices). In a microservice architecture, a single application is developed as a suite of smaller microservices. A microservice can run as a corresponding process and communicate with other systems or services through a lightweight mechanism, such as a hypertext transport protocol (HTTP) resource application programming interface (API) or communication API provided by an external system.

Microservices-based software architecture design techniques structure an application as a collection of loosely coupled services. A microservices architecture enables individual microservices to be deployed and scaled independently, such as via software containers. Individual microservices can be worked on in parallel by different developer teams, may be built in different programming languages, and can have continuous delivery and deployment flows. As development moves toward cloud-native approaches, it is often desirable to decompose, disintegrate, or otherwise separate existing monolithic applications into microservices.

An MFE framework generally divides a web application into multiple units, where each unit is developed, tested, and deployed independently from the other units. The MFE units typically relate to UI features, which can be recombined (e.g., as pages and/or components) to provide a cohesive user experience.

In MFE architectures, the concept of microservices is applied to the frontend (e.g., development of UIs). Similar to microservices, developing MFEs can provide benefits relative to monolithic development. For example, each MFE acts as a small, independent application, which increases flexibility by allowing different teams to manage functionality for respective MFEs. In this way, each team can deploy its own continuous integration and continuous deployment (CI/CD) process and can control when new versions of an MFE are published.

Although MFE frameworks can reduce dependencies between functional teams, they also present some user experience issues. For example, there are often multiple MFEs for a given page of a web application, where the MFEs can have interdependencies (e.g., resources that are used by two or more of the MFEs). MFE resources can be stored in caches to improve performance. Typically, there can be one or more server-side caches (e.g., storing configuration parameters and data) and one or more client-side caches (e.g., storing icons, images, cascading style sheets (CSSs), data, etc.).

When a new MFE version is deployed, the server-side cache is managed and updated using a CI/CD process. However, neither the application (e.g., a container application) nor the client browser will be aware of the changes in the new MFE version, which can cause at least some of the resources in the client-side cache to become outdated (or stale). In this situation, the browser either loads the stale resources from the cache to render the functionality associated with the MFE, or the stale resources might even cause the application to crash. This was not an issue for monolithic applications as they only maintain a single client cache, whereas a single page in an MFE framework may be supported by multiple MFEs, where each MFE is treated as an independent application with its own cache. Due to this added complexity, some conventional techniques disable the client-side cache altogether and force the resources to be loaded from the server. This reduces performance and also requires additional network resources. Other techniques require a user to perform a “hard” refresh of the cache in response to each new MFE version, which negatively affects the user experience (as the user may have to perform a hard refresh for multiple MFEs). At least some conventional techniques implement a timer to reload the cache periodically, which can also negatively affect the user experience as the updated MFE versions may not be seen by the user until after expiry of the timer.

Embodiments described herein provide cache management techniques that can address one or more of these issues, by managing cache resources across multiple MFEs, and selectively prefetching and refreshing the cache resources based at least in part on user activity. These and other embodiments, for example, can effectively avoid disrupting the customer experience and/or requiring the user to perform a runtime hard refresh in response to a new MFE version.

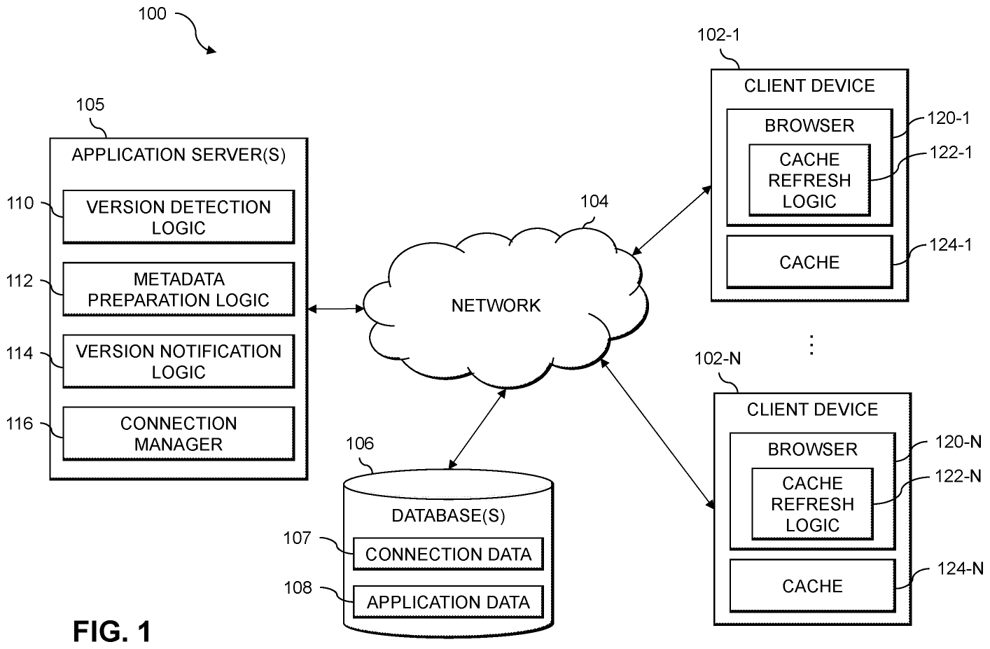

FIG. 1 shows an information processing system 100 configured in accordance with an illustrative embodiment for cache management for web application components. The computer network 100 comprises a plurality of client devices 102-1, . . . 102-N, collectively referred to herein as client devices 102. The client devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is at least one application server 105.

The client devices 102 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The client devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Each of the client devices 102 may implement a browser 120-1, . . . 120-N (collectively, browsers 120) comprising cache refresh logic 122-1, . . . 122-N (collectively, cache refresh logic 122), and at least one cache 124, . . . 124-N (collectively, caches 124).

It is to be appreciated that the term “cache” in the context of a browser is intended to be broadly construed so as to encompass, for example, a local storage area that stores resources related to one or more online sources. For example, the cache 124-1 may be implemented using at least one of a memory or a disk corresponding to the client device 102-1.

Each browser 120 can be configured to run at least one respective application that accesses data services and/or resources associated with the at least one application server 105. At least some of the data services and/or resources can be used to render one or more portions of one or more UIs of the applications (e.g., web applications running in the browsers 120), which can each comprise one or more MFEs. Each of the client devices 102 can be associated with one or more respective users that interact with the one or more UIs. It is to be appreciated that the term “user” in this context and elsewhere herein is intended to be broadly construed so as to encompass, for example, human, hardware, software or firmware entities, as well as various combinations of such entities.

Generally, the cache refresh logic 122-1 is configured to refresh the portions of the cache 124-1 to account for resource changes associated with new versions of one or more components (e.g., MFEs) associated with a web application, as described in more detail elsewhere herein.

While FIG. 1 shows an example wherein each of the client devices 102 runs a single instance of a browser 120, embodiments are not limited to this arrangement. Instead, each of the client devices 102 may run multiple browsers 120, potentially each running one or more instances of one or more web applications. Also, although cache refresh logic 122-1 is shown within browser 120-1, it is to be appreciated that in other embodiments the cache refresh logic 122-1 can be implemented as a standalone software module or software plugin.

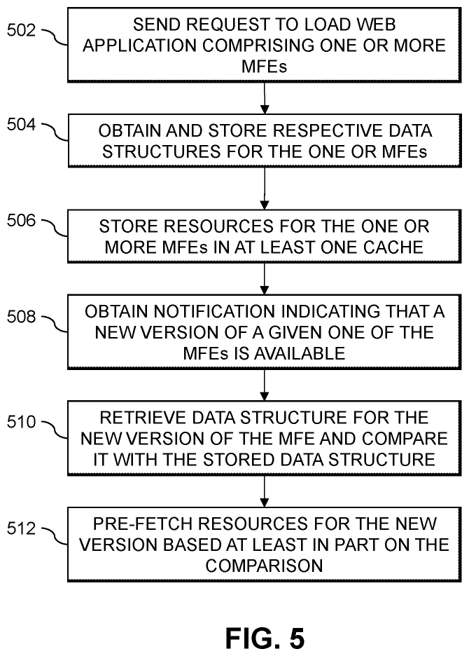

An exemplary process utilizing cache refresh logic 122-1 of an example client device 102-1 will be described in more detail with reference to, for example, the flow diagram of FIG. 5.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the at least one application server 105 can have at least one associated database 106 configured to store data pertaining to, for example, connection data 107 and/or application data 108. By way of example, the connection data 107 may include information related to one or more connections between at least a portion of the client devices 102 and the at least one application server 105. The application data 108, in some embodiments, can include data corresponding to at least one application, such as source code, configuration data, and/or other resources.

An example database 106, such as depicted in the present embodiment, can be implemented using one or more storage systems associated with the at least one application server 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Additionally, the at least one application server 105 in the FIG. 1 embodiment is assumed to be implemented using at least one processing device. Each such processing device generally comprises at least one processor and an associated memory, and implements one or more functional modules for controlling certain features of the application server 105.

More particularly, the at least one application server 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the at least one application server 105 to communicate over the network 104 with the client devices 102, and illustratively comprises one or more conventional transceivers.

The at least one application server 105 further comprises version detection logic 110, metadata preparation logic 112, version notification logic 114, and a connection manager 116.

In some embodiments, the version detection logic 110 is configured to detect when a new version of a component (e.g., an MFE) of the web application is deployed. In response to detecting a new version of a component, the metadata preparation logic 112 generates a data structure comprising information indicating the resources being used by the new version of the component, and the version notification logic 114 sends a notification of the new version to at least some of the client devices 102. The connection manager 116 monitors connections of client devices 102 with the at least one application server 105. For example, the connection manager 116 can store connection information in the at least one database 106 (e.g., as the connection data 107) in response to obtaining requests from one or more of the browsers 120 of the client devices 102. The connection information, in some embodiments, can be used by the version notification logic 114 to notify one or more of the client devices 102 that have an active session with the at least one application server 105.

It is to be appreciated that this particular arrangement of elements 110, 112, 114, and 116 illustrated in the at least one application server 105 of the FIG. 1 embodiment is presented by way of example only, and alternative arrangements can be used in other embodiments. For example, the functionality associated with the elements 110, 112, 114, and 116 in other embodiments can be combined into a single module, or separated across a larger number of modules. As another example, multiple distinct processors can be used to implement different ones of the elements 110, 112, 114, and 116 or portions thereof.

At least portions of elements 110, 112, 114, and 116 may be implemented at least in part in the form of software that is stored in memory and executed by a processor.

It is to be understood that the particular set of elements shown in FIG. 1 for the at least one application server 105 involving client devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the elements 110, 112, 114, and 116 of application server 105 and database(s) 106 can be on and/or part of the same processing platform.

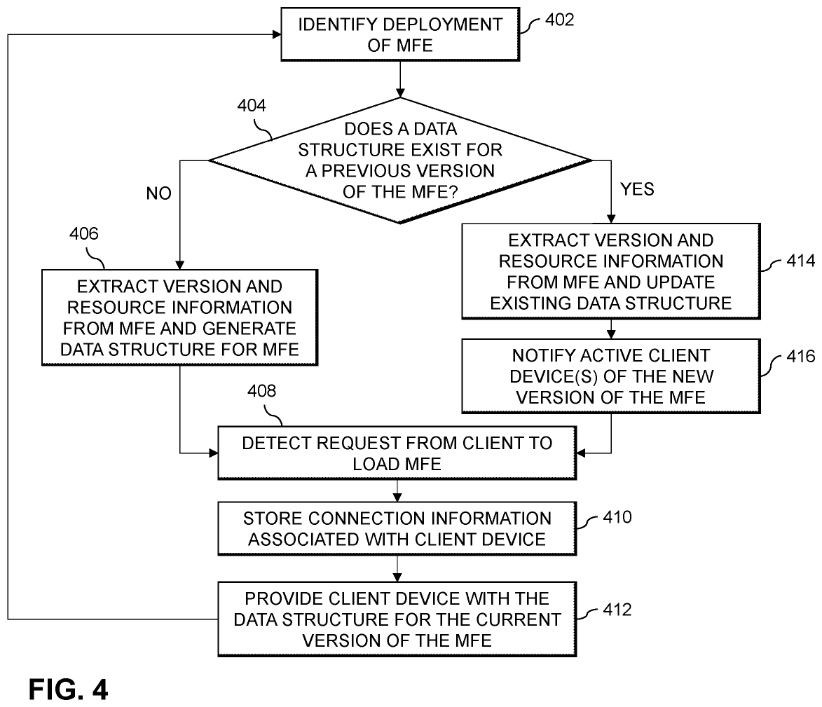

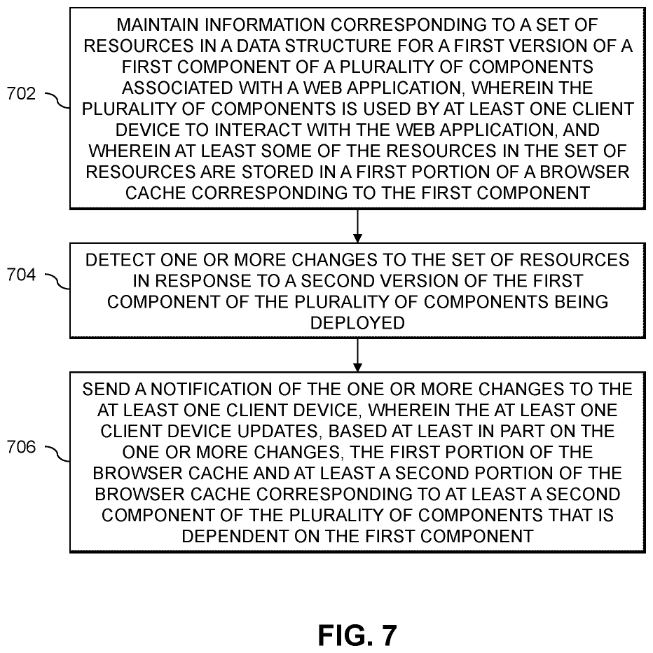

An exemplary process utilizing elements 110, 112, 114, and 116 of an example application server 105 in computer network 100 will be described in more detail with reference to, for example, the flow diagrams of FIGS. 4 and 7.

The term “processing platform” as used herein is intended to be broadly construed so as to encompass, by way of illustration and without limitation, multiple sets of processing devices and one or more associated storage systems that are configured to communicate over one or more networks. For example, distributed implementations of the client devices 102, the at least one database 106, and/or the at least one application server 105 are possible, in which certain ones of the client devices 102 and/or the at least one application server 105 reside in one data center in a first geographic location while other ones of the client devices 102 and/or the at least one application server 105 reside in one or more other data centers in at least a second geographic location that is potentially remote from the first geographic location. The at least one database 106 may be implemented at least in part in the first geographic location, the second geographic location, and one or more other geographic locations.

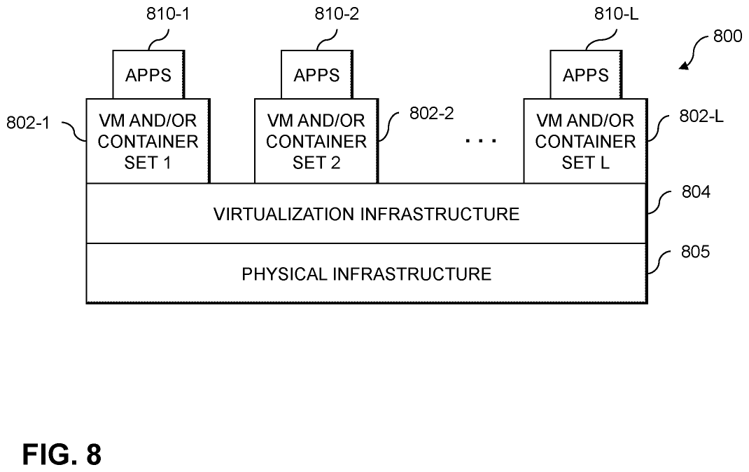

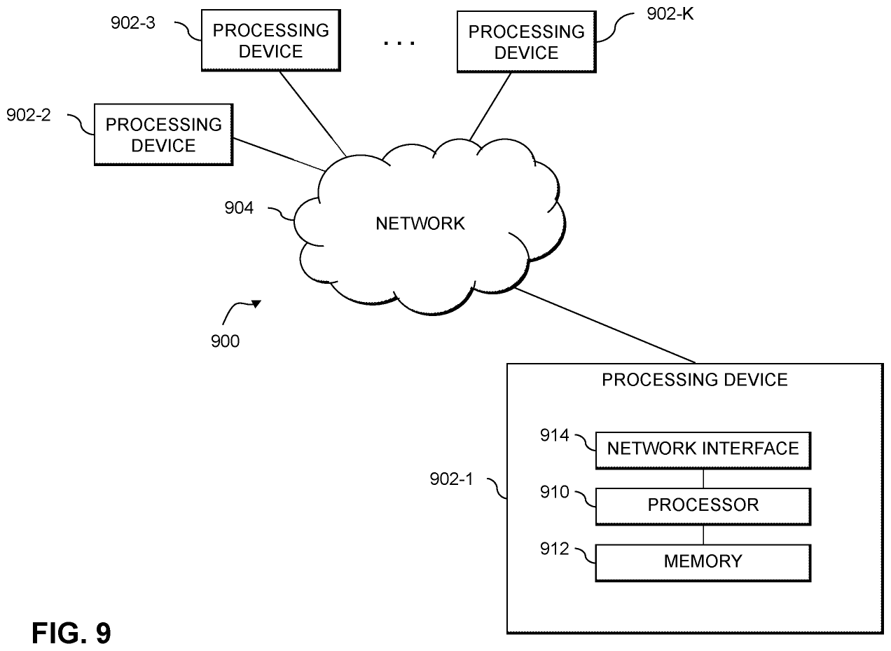

Additional examples of processing platforms utilized to implement portions of the system 100 in illustrative embodiments will be described in more detail below in conjunction with FIGS. 8 and 9.

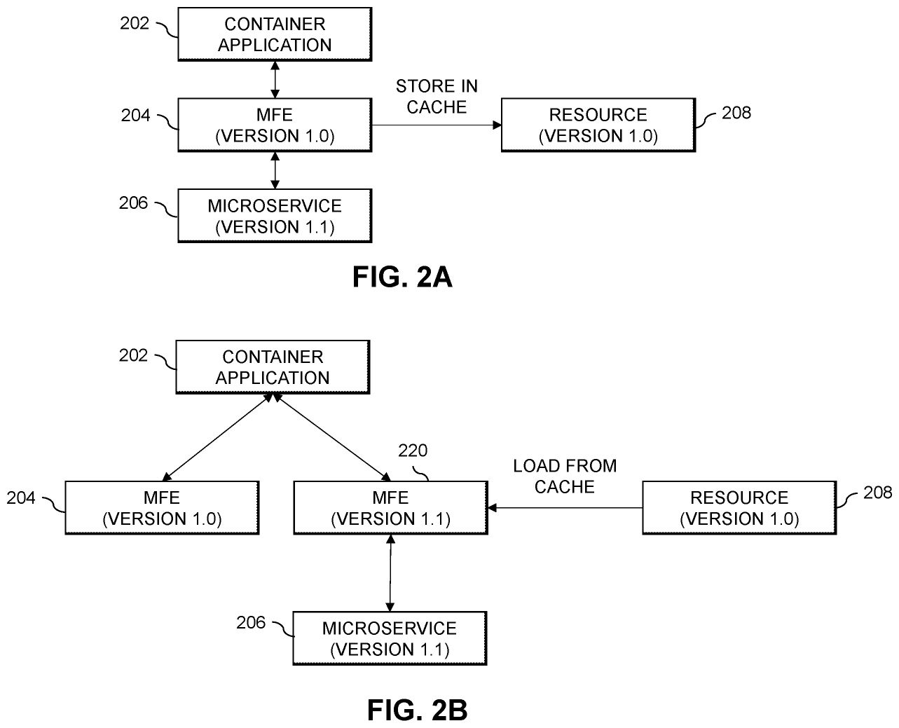

Conventional techniques for managing cache resources in an MFE framework often result in performance problems and/or user experience issues. Consider the example in FIG. 2A, which shows a caching process for an initial version of an MFE associated with a container application 202. The container application 202 includes a first version of an MFE 204 (version 1.0), which uses a first version of a microservice 206 (version 1.1). In this example, it is assumed that a browser (e.g., browser 120-1) stores a resource 208 corresponding to MFE 204 in a cache.

It is noted that caching resources can generally be performed when the browser loads a new page for the first time, and saves the resources (e.g., images, icons, html, and/or CSS components) into a local cache. The next time the browser loads the page, then the browser can use the resources in the local cache to render the web page instead of re-loading the resources from a server.

As a more detailed example, the container application 202 can correspond to an application for an e-Commerce website, which includes multiple MFEs that support individual domain experiences. The container application 202 can be accessed via the e-Commerce website (e.g., example.com), and the MFE 204 can correspond to a “checkout” domain (e.g., checkout.example.com). The other MFEs (not explicitly shown in FIG. 2A) can correspond to other domains (e.g., a product domain, a browse domain, a product order domain, a shopping cart domain, a ratings/feedback domain, etc.). Each of the MFEs can be developed, deployed, and managed independently. Accordingly, MFE 204 can be configured to run the web application in a browser, and can provide a unified experience when a user browses from a base page of the container application 202 to a specific feature/action (e g., corresponding to MFE 204)

In some situations, the microservice 206 can be updated, and can update a data element that is incompatible with MFE 204. This can potentially lead to unexpected behavior or even a crash when the UI is rendered to the user.

FIG. 2B shows that a new version of MFE 204 is deployed as MFE 220 (version 1.1), which results in inconsistencies. It is assumed that MFE 220 replaces or updates the resource 208; however, the cached version of the resource 208 will still be loaded from the cache and rendered to the UL. To avoid this type of inconsistency, a hard refresh of the cache typically needs to be performed for each new MFE version added to the container application 202.

A given MFE resource can also be used by multiple MFEs For example, a product card view, a product details view, and a checkout view can each correspond to a different MFE, that each use the same resource (e.g., a product icon). The container application generally is not aware of changes to MFEs when new versions are deployed. Thus, if the product icon of only one of the MFEs (e.g., the product card view) is updated, then a hard cache refresh will only update the icon in the product card view, and not in the other views. This can lead to an inconsistent user experience as different icons are used by different MFEs.

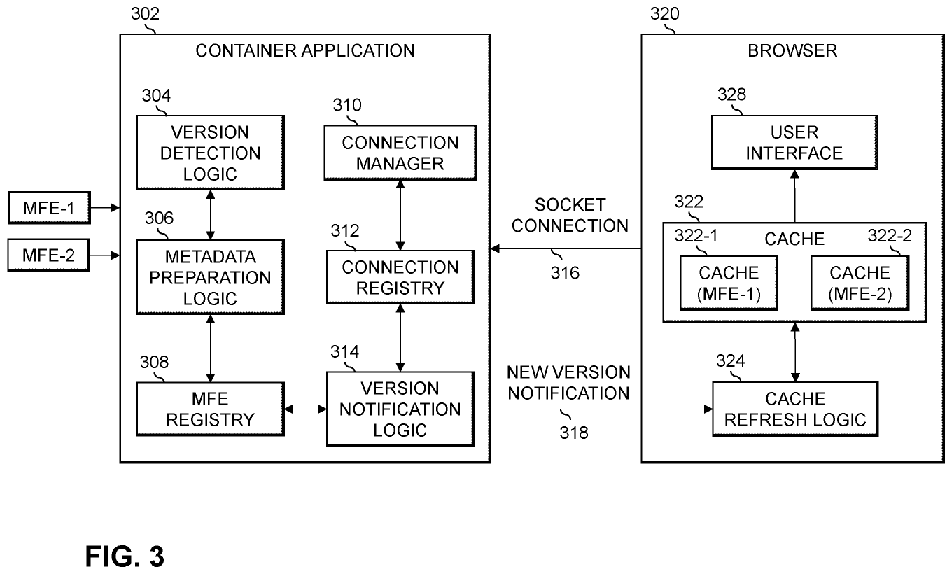

FIG. 3 shows an implementation of an MFE framework for managing a browser cache in an illustrative embodiment. The example shown in FIG. 3 includes a container application 302, which in some embodiments can be deployed on one or more servers (e.g., application server 105), and can be run as a web application by a browser 320.

The container application 302 includes version detection logic 304, metadata preparation logic 306, an MFE registry 308, a connection manager 310, a connection registry 312, and version notification logic 314. Also shown in FIG. 3 are two MFEs (labeled MFE-1 and MFE-2) that are deployed to the container application 302.

The version detection logic 304 detects the deployments of MFE-1 and MFE-2 and extracts metadata information from MFE-1 and MFE-2 (e.g., version information, resources used, and/or any interdependencies between the MFEs). The metadata preparation logic 306 then stores the extracted metadata information in the MFE registry 308. For example, the metadata preparation logic 306, in at least some embodiments, can create a respective data structure for each of MFE-1 and MFE-2, and store the data structures in the MFE registry 308. The connection manager 310 identifies connection information associated with incoming requests, and stores the connection information in the connection registry 312. For example, the browser 320 can initiate a socket connection 316 (e.g., with an application server corresponding to the container application 302), and in response, the connection manager 310 can store the information associated with socket connection 316 in the connection registry 312. In at least some embodiments, approval from a user of the browser 320 can be required prior to storing the connection information.

The browser 320 can send a request via socket connection 316 to run the container application 302. The browser 320 can then load the resources that are needed for running the container application 302, which includes MFE-1 and MFE-2. It is assumed that the first time the browser 320 loads MFE-1 and MFE-2, it stores at least some of the resources associated with MFE-1 and MFE-2 in respective portions 322-1 and 322-2 of a cache 322 of the browser 320. The resources stored in the cache 322 can be used to compose and render information to a user interface (UI) 328. For example, in some embodiments the browser 320 can load a UI composer that can retrieve and combine information associated with MFEs so that it can be displayed on the UI 328.

When a new MFE version (e.g., a new version of MFE-1) is deployed to the container application 302, the data structure updates the data structure in the MFE registry 308 for MFE-1. The version notification logic 314 uses the connection registry 312 to determine any active connections, and send a new version notification to the client devices associated with the active connections. In the FIG. 3 example, it is assumed that the version notification logic 314 determines that the socket connection 316 is an active connection, and sends a new version notification 318 to the cache refresh logic 324 of the browser 320. In at least some embodiments, the new version notification 318 can comprise the metadata information generated for the new version of MFE-1 from the MFE registry 308. In some embodiments, the version notification logic 314 can also expose an API end point for any client device (or a particular set of client devices) to retrieve the metadata information from the MFE registry 308 when the MFEs are loaded for the first time by a given client device.

In response to receiving the new version notification 318, the cache refresh logic 324, in some embodiments, compares the metadata information corresponding to the new version notification 318 with the metadata information for the previous version of MFE-1 to determine whether there are any stale resources in the portions 322-1 of the cache 322 that need to be updated. If so, then the cache refresh logic 324 can retrieve the updated resources from the container application 302, for example.

In some embodiments, the cache refresh logic 324 can also include identifying whether the stale resources are used by any other MFEs by the browser 320. As an example, the cache refresh logic 324 can analyze a user's browsing history with the browser 320 to determine and pre-load the new versions of the MFE resources for other MFEs (e.g., that are dependent or interdependent on MFE-1) based at least in part on the browsing history. As an example, the new version notification 318 can be processed to refresh the cache resources corresponding to the MFEs of the container application that are identified in the browsing history. In at least some embodiments, the analysis of the browsing history and the preloading of the resources can be dependent upon a user providing authorization.

FIG. 4 shows a flow diagram of a server-side process for cache resource management in an illustrative embodiment. It is to be understood that this particular process is only an example, and that additional or alternative processes may be used in other embodiments.

In this embodiment, the process includes steps 402 through 416. These steps are assumed to be performed by the at least one application server 105 utilizing at least in part elements 110, 112, 114, and 116.

The process begins at step 402, which includes identifying a deployment of an MFE. Step 404 includes a test to determine whether a data structure exists for a previous version of the MFE. If no, then the process continues to step 406, which includes extracting version and resource information from the MFE and generating a data structure for the MFE based on the information. Step 408 includes detecting a request from a client device to load the MFE, and step 410 includes storing connection information associated with the client device. Step 412 includes providing the client device with the data structure for the current version of the MFE. The process then returns to step 402 to identify deployment of any additional version of the MFE.

If a data structure for the MFE already exists for a previous version of the MFE at step 404, then the process continues to step 414, which includes extracting the version and resource information from the MFE, and updating the existing data structure. For example, the existing data structure can be updated to account for any changes between the extracted information and the information that was stored in the existing data structure. Step 416 includes notifying any active client devices of the new version of the MFE. The process then continues to step 408 to process other client devices (e.g., client devices connecting for the first time) as described above.

FIG. 5 shows a flow diagram of a client-side process for cache resource management in an illustrative embodiment. It is to be understood that this particular process is only an example, and that additional or alternative processes may be used in other embodiments.

In this embodiment, the process includes steps 502 through 512. These steps are assumed to be performed by the client device 102-1 utilizing at least in part its elements 120-1, 122-1, and 124-1.

Step 502 includes sending a request to load a web application comprising one or more MFEs. Step 504 includes obtaining and storing respective data structures for the one or more MFEs. Step 506 includes storing resources for the MFEs in at least one cache (e.g., cache 124-1). Step 508 includes obtaining notification indicating that a new version of a given one of the MFEs is available. In at least some embodiments, the notification can be received during active session, or the new version and metadata information when connecting to the server to load the MFE. Step 510 includes retrieving the data structure for the new version of the MFE, and comparing it with the stored data structure. Step 512 includes preloading resources for the new version of the MFE based at least in part on the comparison. In at least some embodiments, step 512 can also include checking whether there are any other MFEs in the cache that use at least some of the same resources, and then updating those resources based on the user's browsing history.

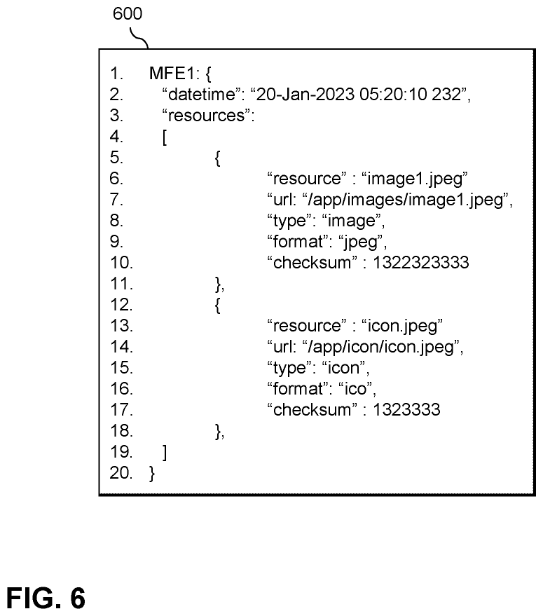

FIG. 6 shows an example of a metadata structure 600 for an MFE (“MFE1”) in an illustrative embodiment. In this example, it is assumed that the metadata structure 600 was generated by the metadata preparation logic 112. The metadata structure 600 in this examples includes a time stamp at line 2, and a list of resources beginning at line 3. More specifically, the metadata structure 600 includes information for two exemplary resources. For each of the resources, the metadata information includes the name of the resource, a URL, a type of the resource, a format of the resource, and a checksum for the resource. It is to be appreciated that the metadata structure 600 in at least some embodiments can be encrypted and/or compressed before it is transmitted.

In at least some embodiments, a client device (e.g., using cache refresh logic 122-1) can extract and/or retrieve metadata information from a client-side cache for a specific MFE, and then compare that metadata information to metadata information specified for a new version of the MFE to determine resources are stale and/or if there are any new resources. The client device can also identify whether the same resources are being used across multiple MFEs (e.g., based on the checksum and format verification in metadata structure 600), and update those resources as needed.

FIG. 7 is a flow diagram of a process for cache management for web application components in an illustrative embodiment. It is to be understood that this particular process is only an example, and additional or alternative processes can be carried out in other embodiments.

In this embodiment, the process includes steps 702 through 706. These steps are assumed to be performed by the at least one application server 105 utilizing at least in part its elements 110, 112, 114, and 116.

Step 702 includes maintaining information corresponding to a set of resources in a data structure for a first version of a first component of a plurality of components associated with a web application, wherein the plurality of components is used by at least one client device to interact with the web application, and wherein at least some of the resources in the set of resources are stored in a first portion of a browser cache corresponding to the first component.

Step 704 includes detecting one or more changes to the set of resources in response to a second version of the first one of the plurality of components being deployed.

Step 706 includes sending a notification of the one or more changes to the at least one client device, wherein the at least one client device updates the first portion of the browser cache and at least a second portion of the browser cache corresponding to at least a second component of the plurality of components that is dependent on the first component.

The second portion of the browser cache may be updated based at least in part on whether a user of the client device previously interacted with the second component. The one or more changes may include at least one of: adding a new resource to the set of resources; and changing one or more of the resources in the set of resources. The process may further include the step of maintaining connection information for one or more connections between the web application and a plurality of client devices. Sending the notification may include: determining one or more of the plurality of client devices having an active connection with the web application based on the connection information; and sending the notification to the one or more client devices having the active connection. The plurality of components may include one or more micro-frontend components. The information maintained for a given resource in the set may include one or more of: an identifier of the given resource; a type of the given resource; an address of the given resource; a format of the given resource; and a checksum computed for the given resource. The client device determines that the first component and the second component comprise a same resource based on the maintained information for the set of resources. The notification may include updated information for the set of resources based on the one or more changes, and sending the notification may include at least one of encrypting and compressing at least a portion of the notification. The one or more changes to the set of resources may include at least one change to a part of a given resource in the set, and the at least one client device may update the part of the given resource that is stored in the first portion of the browser cache and the second portion of the browser cache without updating one or more other parts of the given resource.

Accordingly, the particular processing operations and other functionality described in conjunction with the flow diagram of FIG. 7 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to significantly improve performance and reduce inconsistencies with UIs for MFE frameworks. These and other embodiments can effectively overcome problems associated with existing techniques. For example, some embodiments are configured to automatically identify changes in resources associated with different versions of a given MFE, and update the resources stored in a cache for the MFE as well as the one or more other MFEs that use the same resources.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

Illustrative embodiments of processing platforms will now be described in greater detail with reference to FIGS. 8 and 9. Although described in the context of system 100, these platforms may also be used to implement at least portions of other information processing systems in other embodiments.

FIG. 8 shows an example processing platform comprising cloud infrastructure 800. The cloud infrastructure 800 comprises a combination of physical and virtual processing resources that are utilized to implement at least a portion of the information processing system 100. The cloud infrastructure 800 comprises multiple virtual machines (VMs) and/or container sets 802-1, 802-2, . . . 802-L implemented using virtualization infrastructure 804. The virtualization infrastructure 804 runs on physical infrastructure 805, and illustratively comprises one or more hypervisors and/or operating system level virtualization infrastructure. The operating system level virtualization infrastructure illustratively comprises kernel control groups of a Linux operating system or other type of operating system.

The cloud infrastructure 800 further comprises sets of applications 810-1, 810-2, . . . 810-L running on respective ones of the VMs/container sets 802-1, 802-2, . . . 802-L under the control of the virtualization infrastructure 804. The VMs/container sets 802 comprise respective VMs, respective sets of one or more containers, or respective sets of one or more containers running in VMs. In some implementations of the FIG. 8 embodiment, the VMs/container sets 802 comprise respective VMs implemented using virtualization infrastructure 804 that comprises at least one hypervisor.

A hypervisor platform may be used to implement a hypervisor within the virtualization infrastructure 804, wherein the hypervisor platform has an associated virtual infrastructure management system. The underlying physical machines comprise one or more distributed processing platforms that include one or more storage systems.

In other implementations of the FIG. 8 embodiment, the VMs/container sets 802 comprise respective containers implemented using virtualization infrastructure 804 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 800 shown in FIG. 8 may represent at least a portion of one processing platform. Another example of such a processing platform is processing platform 900 shown in FIG. 9.

The processing platform 900 in this embodiment comprises a portion of system 100 and includes a plurality of processing devices, denoted 902-1, 902-2, 902-3, . . . 902-K, which communicate with one another over a network 904.

The network 904 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 902-1 in the processing platform 900 comprises a processor 910 coupled to a memory 912.

The processor 910 comprises a microprocessor, a microcontroller, an ASIC, an FPGA or other type of processing circuitry, as well as portions or combinations of such circuitry elements.

The memory 912 comprises RAM, ROM or other types of memory, in any combination. The memory 912 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 902-1 is network interface circuitry 914, which is used to interface the processing device with the network 904 and other system components, and may comprise conventional transceivers.

The other processing devices 902 of the processing platform 900 are assumed to be configured in a manner similar to that shown for processing device 902-1 in the figure.

Again, the particular processing platform 900 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
maintaining information corresponding to a set of resources in a data structure for a first version of a first component of a plurality of components associated with a web application, wherein the plurality of components is used by at least one client device to interact with the web application, and wherein at least some of the resources in the set of resources are stored in a first portion of a browser cache corresponding to the first component;
detecting one or more changes to the set of resources in response to a second version of the first component of the plurality of components being deployed; and
sending a notification of the one or more changes to the at least one client device, wherein the at least one client device updates, based at least in part on the one or more changes, the first portion of the browser cache and at least a second portion of the browser cache corresponding to at least a second component of the plurality of components that is dependent on the first component;
wherein the method is performed by at least one processing device comprising a processor coupled to a memory.

2. The computer-implemented method of claim 1, wherein the second portion of the browser cache is updated based at least in part on whether a user of the client device previously interacted with the second component.

3. The computer-implemented method of claim 1, wherein the one or more changes comprise at least one of:
adding a new resource to the set of resources; and
changing one or more of the resources in the set of resources.

4. The computer-implemented method of claim 1, further comprising:
maintaining connection information for one or more connections between the web application and a plurality of client devices.

5. The computer-implemented method of claim 4, wherein the sending the notification comprises:
determining one or more of the plurality of client devices having an active connection with the web application based on the connection information; and
sending the notification to the one or more client devices having the active connection.

6. The computer-implemented method of claim 1, wherein the plurality of components comprise one or more micro-frontend components.

7. The computer-implemented method of claim 1, wherein the information maintained for a given resource in the set comprises one or more of:
an identifier of the given resource;
a type of the given resource;
an address of the given resource;
a format of the given resource; and
a checksum computed for the given resource.

8. The computer-implemented method of claim 1, wherein the client device determines that the first component and the second component comprise a same resource based on the maintained information for the set of resources.

9. The computer-implemented method of claim 1, wherein the notification comprises updated information for the set of resources based on the one or more changes, and wherein sending the notification comprises at least one of encrypting and compressing at least a portion of the notification.

10. The computer-implemented method of claim 1, wherein the one or more changes to the set of resources comprise at least one change to a part of a given resource in the set, and wherein the at least one client device updates the part of the given resource that is stored in the first portion of the browser cache and the second portion of the browser cache without updating one or more other parts of the given resource.

11. A non-transitory processor-readable storage medium having stored therein program code of one or more software programs, wherein the program code when executed by at least one processing device causes the at least one processing device:
to maintain information corresponding to a set of resources in a data structure for a first version of a first component of a plurality of components associated with a web application, wherein the plurality of components is used by at least one client device to interact with the web application, and wherein at least some of the resources in the set of resources are stored in a first portion of a browser cache corresponding to the first component;
to detect one or more changes to the set of resources in response to a second version of the first component of the plurality of components being deployed; and
to send a notification of the one or more changes to the at least one client device, wherein the at least one client device updates, based at least in part on the one or more changes, the first portion of the browser cache and at least a second portion of the browser cache corresponding to at least a second component of the plurality of components that is dependent on the first component.

12. The non-transitory processor-readable storage medium of claim 11, wherein the second portion of the browser cache is updated based at least in part on whether a user of the client device previously interacted with the second component.

13. The non-transitory processor-readable storage medium of claim 11, wherein the one or more changes comprise at least one of:
adding a new resource to the set of resources; and
changing one or more of the resources in the set of resources.

14. The non-transitory processor-readable storage medium of claim 11, wherein the program code further causes the at least one processing device:
to maintain connection information for one or more connections between the web application and a plurality of client devices.

15. The non-transitory processor-readable storage medium of claim 14, wherein the sending the notification comprises:
determining one or more of the plurality of client devices having an active connection with the web application based on the connection information; and
sending the notification to the one or more client devices having the active connection.

16. An apparatus comprising:
at least one processing device comprising a processor coupled to a memory;
the at least one processing device being configured:
to maintain information corresponding to a set of resources in a data structure for a first version of a first component of a plurality of components associated with a web application, wherein the plurality of components is used by at least one client device to interact with the web application, and wherein at least some of the resources in the set of resources are stored in a first portion of a browser cache corresponding to the first component;
to detect one or more changes to the set of resources in response to a second version of the first component of the plurality of components being deployed; and
to send a notification of the one or more changes to the at least one client device, wherein the at least one client device updates, based at least in part on the one or more changes, the first portion of the browser cache and at least a second portion of the browser cache corresponding to at least a second component of the plurality of components that is dependent on the first component.

17. The apparatus of claim 16, wherein the second portion of the browser cache is updated based at least in part on whether a user of the client device previously interacted with the second component.

18. The apparatus of claim 16, wherein the one or more changes comprise at least one of:
adding a new resource to the set of resources; and
changing one or more of the resources in the set of resources.

19. The apparatus of claim 16, wherein the at least one processing device is further configured:
to maintain connection information for one or more connections between the web application and a plurality of client devices.

20. The apparatus of claim 19, wherein the sending the notification comprises:
determining one or more of the plurality of client devices having an active connection with the web application based on the connection information; and
sending the notification to the one or more client devices having the active connection.
